(19) United States
(12) Patent Application Publication
(10) Pub. No.: US 2024/0196264 A1
(43) Pub. Date: Jun. 13, 2024

(54) BASE STATION APPARATUS, WIRELESS COMMUNICATION SYSTEM, AND COMMUNICATION CONTROL METHOD

(71) Applicant: Fujitsu Limited, Kawasaki-shi (JP)

(72) Inventor: YOSHINORI TANAKA, Yokohama (JP)

(73) Assignee: Fujitsu Limited, Kawasaki-shi (JP)

(21) Appl. No.: 18/369,243

(22) Filed: Sep. 18, 2023

(30) Foreign Application Priority Data
Dec. 9, 2022 (JP) 2022-197193

(51) Int. Cl. H04W 28/02; H04L 1/00; H04L 1/20

(52) U.S. Cl. CPC H04W 28/0268; H04L 1/0003; H04L 1/0013; H04L 1/0019; H04L 1/203

(57) ABSTRACT

A base station apparatus includes a controller which determines a value of a modulation and channel coding scheme to be applied at a transmission timing of a data packet required to have the decoding error probability not more than a target error rate, and a transmitter which transmits data to a terminal apparatus, wherein the controller acquires a distribution of variations between first communication quality used when the value of the modulation and channel coding scheme is determined and second communication quality at a time of data transmission and determines a correction value of the first communication quality according to the distribution of the variations and the target error rate, and the transmitter transmits the data by using the modulation and channel coding scheme which is determined by communication quality corrected with the correction value.

### CROSS-REFERENCE TO RELATED APPLICATION

This application is based upon and claims the benefit of priority of the prior Japanese Patent Application No. 2022-197193, filed on Dec. 9, 2022, the entire contents of which are incorporated herein by reference.

### FIELD

The present disclosure relates to a base station apparatus, a wireless communication system, and a communication control method.

### BACKGROUND

In the 5th generation mobile communication system (5G), for example, creation of a system for SLA (Service Level Agreement) guarantees is needed in order to utilize normalized communication requirements such as low delay, high reliability, and large capacity in an industrial field.

In particular, it is important to implement SLA guarantees of URLLC (Ultra-Reliable and Low Latency Communications) communication which is used in a mission critical service which does not allow delay such as automation of a factory or remote control in the premises.

A method for controlling wireless communication is described in, e.g., the following documents.

### CITATION LIST

### Patent Literature

PATENT LITERATURE 1: Japanese Laid-open Patent Publication No. 2004-186969
PATENT LITERATURE 2: Japanese National Publication of International Patent Application No. 2010-506537
PATENT LITERATURE 3: Japanese Laid-open Patent Publication No. 2006-325264

### SUMMARY

In a multi-cellular environment, which is often used in a factory or similar settings, there are cases where interference from another cell occurs, resulting in a significant change in the reception SINR (Signal to Interference and Noise Ratio) of a terminal apparatus.

When the reception SINR decreases, there are cases where a block error rate (BLER) increases, a failure rate of packet reception in the terminal apparatus increases, and it is not possible to satisfy requirements of URLLC.

To cope with this, a base station apparatus needs to perform proper control of an MCS (Modulation and channel Coding Scheme) at the time of packet transmission such that packet reception failure does not occur even when the SINR decreases momentarily. Although delay which occurs in control is inevitable, the SINR changes in this control delay time period, and hence it is difficult to perform proper adaptive modulation and channel coding control.

There are provided a controller which determines a value of a modulation and channel coding scheme to be applied at a transmission timing of a data packet required to have an error rate not more than a target error rate, and a transmitter which transmits data to a terminal apparatus, the controller acquires a difference distribution of a difference value in a predetermined time period between first communication quality used when the value of the modulation and channel coding scheme is determined and second communication quality at the time of data transmission and determines an offset value which is added to the value of the modulation and channel coding scheme according to the difference distribution and the target error rate, and the transmitter transmits the data by using the modulation and channel coding scheme to which the offset value is applied.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a view illustrating an example of the configuration of a wireless communication system 10.

FIG. 2 is a view illustrating an example of the configuration of the base station apparatus 200.

FIG. 3 is a view illustrating an example of the configuration of the terminal apparatus 100.

FIG. 4 is a view illustrating an example of a conditional SIR change amount cumulative distribution of each MCS.

FIG. 5 is a view illustrating an example of the SIR change amount distribution.

FIG. 6 is a view illustrating an example of the CQI distribution.

FIG. 7 is a view illustrating an example of the SIR change amount.

### DESCRIPTION OF EMBODIMENTS

### First Embodiment

A first embodiment will be described.

### With Regard to Wireless Communication System 10

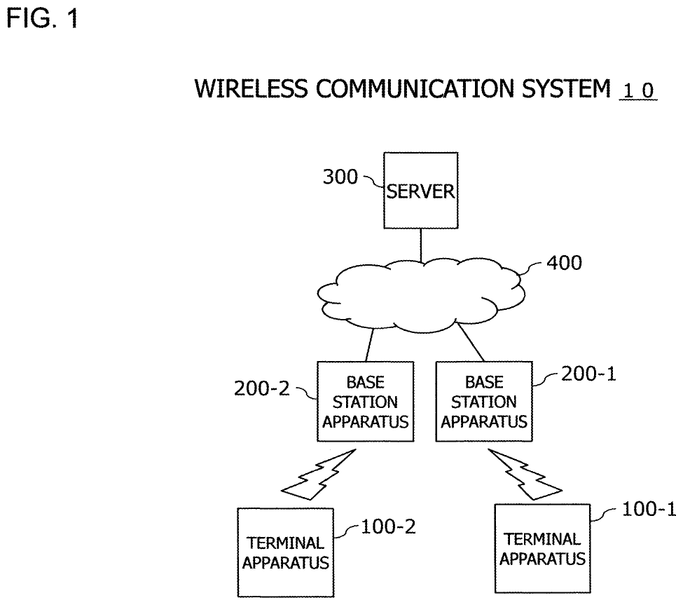

FIG. 1 is a view illustrating an example of the configuration of a wireless communication system 10. The wireless communication system 10 has base station apparatuses 200-1 and 200-2, terminal apparatuses 100-1 and 100-2, a network 400, and a server 300. The wireless communication system 10 is a communication system which implements a multi-cell environment having a plurality of cells, and is installed in, e.g., a factory or a business facility.

The base station apparatuses 200-1 and 200-2 (hereinafter referred to as a base station apparatus 200 in some cases) are apparatuses which are wirelessly connected to the terminal apparatuses 100-1 and 100-2 (hereinafter referred to as a terminal apparatus 100 in some cases) to perform wireless communication, and are, e.g., eNodeBs or gNodeBs. The base station apparatus 200 corresponds to communication generations such as, e.g., 5G and NR (New Radio). In addition, the base station apparatus 200 may be constituted by one unit and may also be constituted by a plurality of CUs (Central Units) or DUs (Distributed Units). The base station apparatuses 200-1 and 200-2 have different cells (wireless communication areas), and are present in, e.g., an area in which part or all of their cells overlap each other.

The terminal apparatus 100 is a reception apparatus which is wirelessly connected to the base station apparatus 200 to perform transmission and reception of a data packet, and is, e.g., a smartphone, a tablet, or equipment having wireless communication function in a factory.

The server 300 communicates with the base station apparatus 200 via the network 400 to control the base station apparatus 200.

The network 400 is a network via which communication between the base station apparatus 200 and the server 300 is performed, and is constituted by the external Internet or a local network in addition to a core network of a mobile communication network.

### Example of Configuration of Base Station Apparatus 200

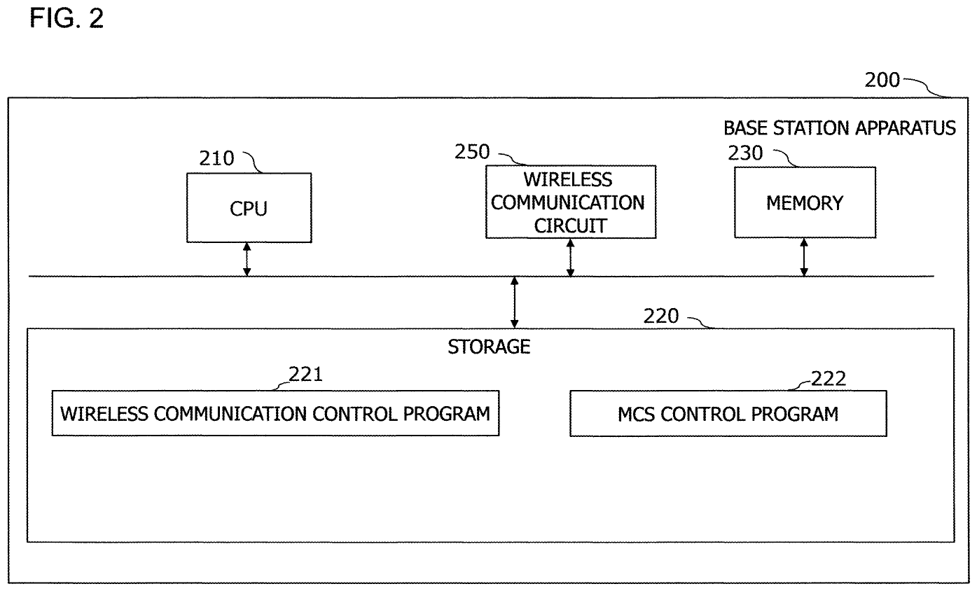

FIG. 2 is a view illustrating an example of the configuration of the base station apparatus 200. The base station apparatus 200 has a CPU (Central Processing Unit) 210, a storage 220, a memory 230, and a wireless communication circuit 250.

The storage 220 is an auxiliary storage apparatus such as a flash memory, an HDD (Hard Disk Drive), or an SSD (Solid State Drive) which stores a program and data. The storage 220 stores a wireless communication control program 221 and an MCS control program 222.

The memory 230 is an area into which the program stored in the storage 220 is loaded. In addition, the memory 230 may also be used as an area in which the program stores data.

The wireless communication circuit 250 is an apparatus which performs wireless communication with the terminal apparatus 100. The base station apparatus 200 performs transmission and reception of a signal (message) to and from the terminal apparatus 100 via the wireless communication circuit 250.

The CPU 210 is a processor which loads the program stored in the storage 220 into the memory 230, executes the loaded program, constructs each unit, and implements each processing.

The CPU 210 constructs a transmission unit and performs wireless communication control processing by executing the wireless communication control program 221. The wireless communication control processing is processing in which wireless connection to the terminal apparatus 100 is established and transmission and reception of a signal (message) are performed via the established wireless connection. The base station apparatus 200 transmits data to the terminal apparatus 100 in the wireless communication control processing.

The CPU 210 constructs a control unit and performs MCS control processing by executing the MCS control program 222. The MCS control processing is processing in which an MCS used in downlink data transmission is determined (controlled). The MCS control processing is any of steps of processing of first to fourth methods described below or a combination of any of steps thereof.

### Example of Configuration of Terminal Apparatus 100

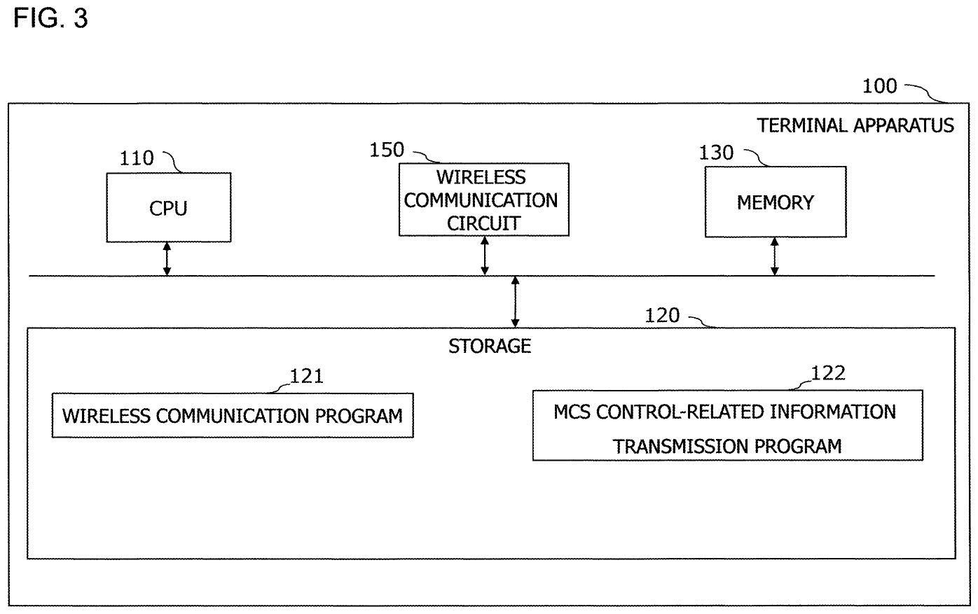

FIG. 3 is a view illustrating an example of the configuration of the terminal apparatus 100. The terminal apparatus 100 has a CPU 110, a storage 120, a memory 130, and a wireless communication circuit 150.

The storage 120 is an auxiliary storage apparatus such as a flash memory, an HDD, or an SSD which stores a program and data. The storage 120 stores a wireless communication program 121 and an MCS control-related information transmission program 122.

The memory 130 is an area into which the program stored in the storage 120 is loaded. In addition, the memory 130 may also be used as an area in which the program stores data.

The wireless communication circuit 150 is an apparatus which performs wireless communication with the base station apparatus 200. The terminal apparatus 100 performs transmission and reception of a signal (message) to and from the base station apparatus 200 via the wireless communication circuit 150.

The CPU 110 is a processor which loads the program stored in the storage 120 into the memory 130, executes the loaded program, constructs each unit, and implements each processing.

The CPU 110 constructs a reception unit and performs wireless communication processing by executing the wireless communication program 121. The wireless communication processing is processing in which wireless connection to the base station apparatus 200 is established and communication is performed. The terminal apparatus 100 receives downlink data from the base station apparatus 200 in the wireless communication processing.

The CPU 110 constructs an information transmission unit and performs MCS control-related information transmission processing by executing the MCS control-related information transmission program 122. The MCS control-related information transmission processing is processing in which MCS control-related information is transmitted to the base station apparatus 200 according to an instruction of the base station apparatus 200. The MCS control-related information includes a measurement value related to a wireless state measured by the terminal apparatus 100 such as, e.g., an SINR, CQI, SIR, or BLER.

### Adaptive Modulation and Channel Coding Control Method

A description will be given of an adaptive modulation and channel coding control method which controls an MCS used in downlink data transmission toward the terminal apparatus 100 by the base station apparatus 200. Hereinafter, each adaptive modulation and channel coding control method will be described. Note that the base station apparatus 200 performs determination of the MCS at the time of data transmission. In addition, the base station apparatus 200 may perform the determination of the MCS at the time of the data transmission when a target value of a BLER in URLLC or the like is high (stringent condition).

In addition, a timing at which the base station apparatus 200 determines the MCS may be, e.g., a reception timing of a signal (message) including a measurement value and data used for the determination of the MCS.

Note that the determined MCS is applied at the time of downlink data packet transmission (transmission timing).

### 1. With Regard to First Method

A first method is a method which uses outer loop control which uses Ack (ACKnowledgement)/Nack (Non-ACKnowledgement) information. The base station apparatus 200 receives a downlink SINR from the terminal apparatus 100. Subsequently, the base station apparatus 200 determines the MCS according to the received SINR, and notifies the terminal apparatus 100 of the determined MCS. The base station apparatus 200 stores the latest SINR value in, e.g., an internal memory.

The base station apparatus 200 adds a correction value determined by the outer loop control to the SINR value to determine the MCS, and the correction value is adjusted every time an Ack or a Nack is received in the first method.

γ′=γ+Δ Expression (1)

Expression (1) is an expression for determining the SINR value after correction. y′ is an SINR value after correction, y is an SINR value before correction, and A is a correction value.

$$\begin{matrix}[ Math . 1 ] & \\ Δ = \{ \begin{matrix}Δ - {Δ}_{down} & if Ack \\ Δ + {Δ}_{up} & if Nack\end{matrix} & Expression ( 2 )\end{matrix}$$

Expression (2) is an expression for performing adjustment of the correction value. if Ack denotes the case where the Ack is received, and if Nack denotes the case where the Nack is received. Each of Adown and Aup represents an adjustment value. Note that Adown and Aup have a relationship of the following Expression (3).

[Math. 2]

Δ_{down}/Δᵤₚ=target BLER Expression (3)

A target BLER is a block error rate serving as a target (requirement), and Adown and Aup are determined according to this numeric value.

In the first method, the adjustment of the correction value is performed sequentially every time the Ack or the Nack is received, and the proper correction value is thereby estimated.

However, for example, in the case where the target BLER is very low, Adown has a very small value, and the Ack reception needs to be performed many times before the proper correction value is obtained. However, the Ack is information which is sent back in the case where a packet is transmitted, and it takes time before the correction value converges to the proper correction value. In particular, in the case where a packet transmission interval is long, it takes time before the correction value converges to the proper correction value. In the case where duration of a call is short, a problem arises in that communication is ended before the correction value converges to the proper correction value. To cope with this, hereinafter, different methods are proposed.

### 2. With Regard to Second Method

A second method is a method which controls a correction value (MCS offset) by using a conditional SIR (signal-to-interference ratio) change amount distribution of each MCS.

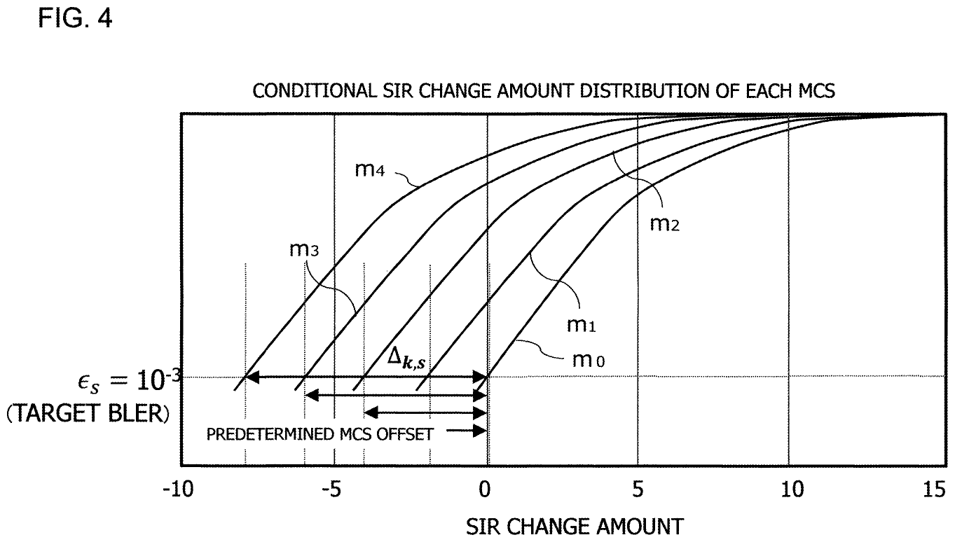

FIG. 4 is a view illustrating an example of a conditional SIR change amount cumulative distribution of each MCS. In a graph in FIG. 4, the horizontal axis indicates an SIR change amount, and the vertical axis indicates a cumulative probability.

The base station apparatus 200 measures the SIR change amount distribution of each selected MCS at any timing (e.g., at the time of start of communication, before start of communication, before system operation, or periodically), and generates the graph illustrated in FIG. 4. Note that the base station apparatus 200 estimates the SIR from, e.g., the CQI.

The SIR change amount is a difference value of the SIR between a beginning of a given time section and an end of the given time section. In addition, the SIR change amount distribution is a distribution of the SIR change amount, and is, e.g., a distribution of the difference value (difference distribution).

The SIR variation is calculated by the following Expression (4).

[Math. 3]

ΔY_{t,T}^{k}=_{t,T}^{k}−yₜ^{k} Expression (4)

y represents the SIR.
represents the SIR variation between time t+t and time t,
Yₜ₊ₜ^{k}
   represents the SIR at time t+t, and
Yₜ^{k}
   represents the SIR at the time t. Note that
Yₜ₊ₜ^{k}
   represents, e.g., the SIR at the time of data reception in the terminal apparatus 100, and
Yₜ^{k}
   represents the SIR at the time of MCS determination. k represents an identification of the terminal apparatus 100.

The distribution of SIR variation conditioned on the current MCS is represented by the following Expression (5).

[Math. 4]

F_{Δy}_{_{τ}}^{k}(z|mₖ(t)=mᵢ) Expression (5)

mk (t) is an MCS value determined from the CQI (Channel Quality Indicator). In addition, i represents an MCS index. FIG. 4 illustrates conditional distributions on MCSs 0 to 4.

As illustrated in FIG. 4, the base station apparatus 200 determines the MCS offset based on the distribution corresponding to the current MCS index. For example, in the case where the MCS is m4 and the target BLER is 10⁻³, a width of an arrow indicated by Δks which is a width between an intersection point (quantile) of a graph of m=4 and the target BLER and the SIR change amount of 0 serves as the MCS offset corresponding to the MCS of m4.

The conditional distribution differs according to the SIR (MCS), and hence the base station apparatus 200 determines the offset corresponding to the MCS. For example, the offset is calculated by the following Expression (6).

[Math. 5]

Δₖ=[−max(z|F_{Δy}_{_{τ}}^{k}(z)mₖ(t)=mᵢ)≤∈ₛ)] Expression (6)

∈s represents the target BLER. The maximum quantile value which is not less than the target BLER is determined to be the offset by the base station apparatus 200.

The base station apparatus 200 determines the MCS by using the following Expression (7).

[Math. 6]

\tilde{m}ₖ(t)=mₖ(t)−Δₖ Expression (7)

As indicated in Expression (7), the base station apparatus 200 determines (changes) the MCS in consideration of the offset.

In the second method, in the base station apparatus 200, it is possible to perform calculation at high speed by calculating the MCS offset by using the CQI which allows acquisition of more samples as compared with the Ack/Nack information and select the MCS which properly corresponds to change of a wireless state.

### 3. With Regard to Third Method

A third method is a method which controls the MCS offset by using the SIR change amount distribution. While the MCS conditional distribution is used in the second method, the conditional distribution of each MCS is not used in the third method.

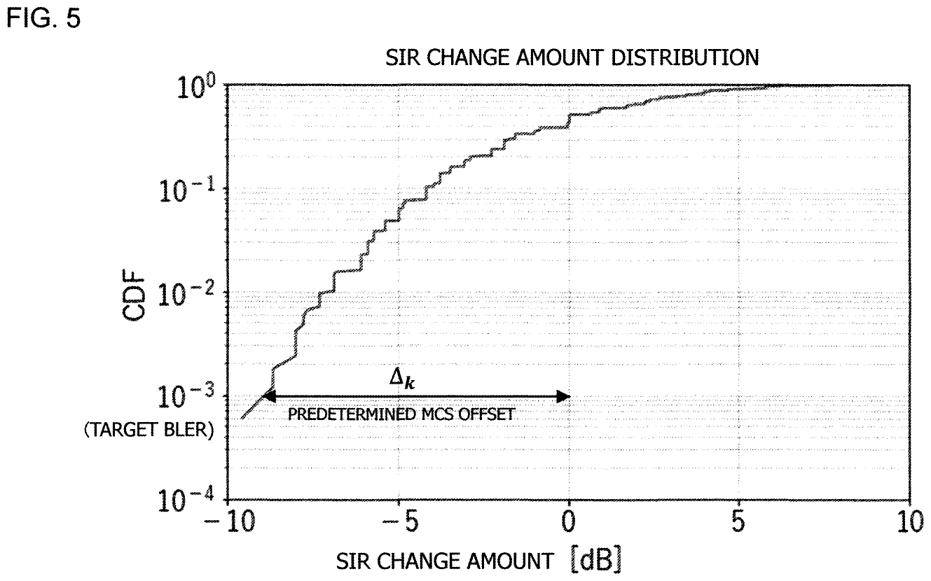

FIG. 5 is a view illustrating an example of the SIR change amount distribution. The base station apparatus 200 measures the SIR change amount distribution at any timing, and generates a graph illustrated in FIG. 5. Note that the base station apparatus 200 estimates the SIR from, e.g., the CQI.

Expression for calculating the SIR change amount is the same as Expression (4) in the second method.

The SIR change amount distribution is represented by the following Expression (8).

[Math. 7]

F_{Δy}_{_{τ}}^{k}(z) Expression (8)

As illustrated in FIG. 5, the base station apparatus 200 determines the MCS offset based on the distribution of the SIR variations and the target BLER. For example, in the case where the target BLER is 10⁻³, a width of an arrow indicated by Δk serves as the offset.

The base station apparatus 200 calculates the offset by, e.g., the following Expression (9).

[Math. 8]

Δₖ=[−max(z|F_{Δy}_{_{τ}}^{k}(z)≤∈ₛ)] Expression (9)

However, when the offset Δₖ is applied in this manner uniformly, there is a possibility that the MCS may be reduced beyond necessity in, e.g., an area in which the SIR is low. To cope with this, in the third method, a lower limit value of a CQI distribution is calculated and a lower limit of the MCS after application of the offset is set.

The base station apparatus 200 determines the MCS by using the following Expression (10).

[Math. 9]

\tilde{m}ₖ(t)=max(mₖ(t)−Δₖ,f(q_{min,k}) Expression (10)

f (q_{min,k}) is obtained by changing a CQI index in the lower limit value of the CQI distribution to an MCS index.

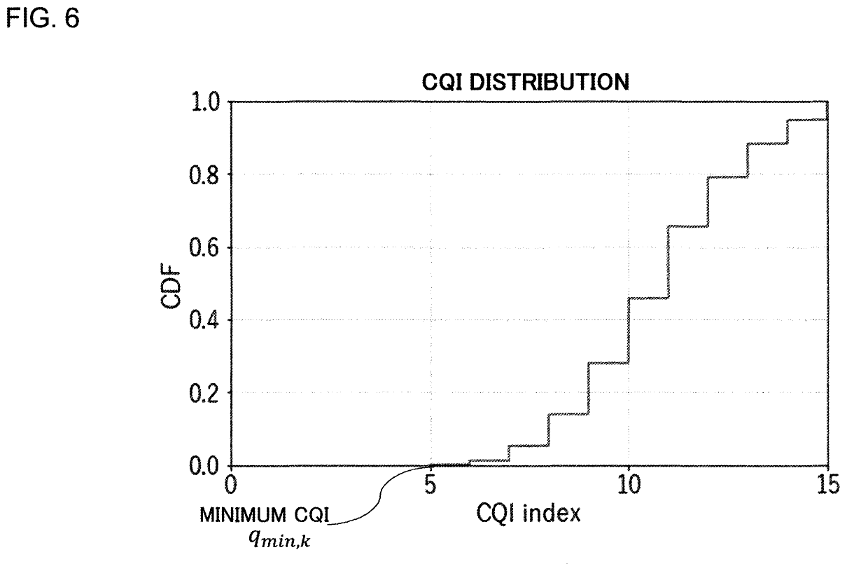

FIG. 6 is a view illustrating an example of the CQI distribution. As illustrated in FIG. 6, the base station apparatus 200 uses the MCS index corresponding to “5” which is the minimum CQI index as the lower limit value in Expression (10).

As indicated in Expression (10), the base station apparatus 200 determines (changes) the MCS in consideration of the offset.

In the third method, in the base station apparatus 200, it is possible to perform calculation at high speed by calculating the MCS offset by using the CQI which allows acquisition of more samples as compared with the Ack/Nack information and select the MCS which properly corresponds to the change of the wireless state.

### 4. With Regard to Fourth Method

A fourth method is a method which applies hierarchical outer loop control in the outer loop control of the second method or the third method.

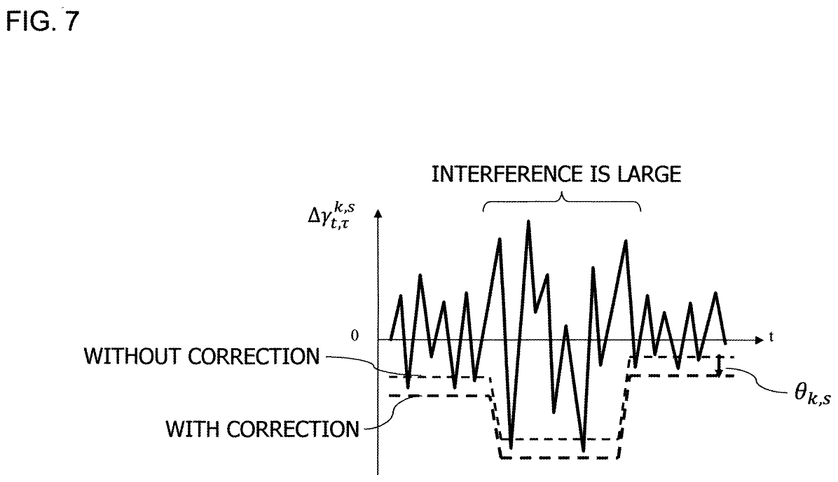

FIG. 7 is a view illustrating an example of the SIR variations. In FIG. 7, for example, the vertical axis indicates the SIR variations, and the horizontal axis indicates time. When the SIR variations in FIG. 7 is large, it may be highly possible that interference occurs (or interference is large). In the fourth method, θ_{k,s} illustrated in FIG. 7 is used as a second correction value (correction amount).

For example, the offset is calculated by the following Expression (11) obtained by adding the second correction value to the calculation expression of the offset of the third method.

[Math. 10]

Δₖₛ=[−max(z|F_{Δy}_{_{τ}}^{k,s}(z)≤∈ₛ)+θ_{k,s}] Expression (11)

θ is updated in, e.g., the following Expression (12) or Expression (14).

Expression (12) is used in the case of sequential update, and Expression (14) is used in the case of block update (update when a predetermined number of Acks/Nacks are received).

Expression (12) is described below.

$$\begin{matrix}[ Math . 11 ] & \\ θ = \{ \begin{matrix}θ - θ down & if Ack & ( after re - transmission ) \\ θ + θ up & if Nack & ( after re - transmission )\end{matrix} & Expression ( 12 )\end{matrix}$$

if Ack (after re-transmission) denotes the case where an ACK after data re-transmission is received, and if Nack (after re-transmission) denotes the case where a Nack after data re-transmission is received. θdown and θup represent adjustment values. Note that θdown and θup have a relationship of the following Expression (13). That is, the method by Ack/Nack is control which is performed according to whether or not data transmission (herein, re-transmission) has an error (presence/absence information of an error).

[Math. 12]

θ_{down}/θᵤₚ=target BLER after re-transmission Expression (13)

Expression (14) is described below.

[Math. 13]

θ=θ−N_{ack}θ_{down}+N_{Nack}θᵤₚ Expression (14)

θ=θ−Nθ_{down}+N_{Nack}(θᵤₚ+θ_{down}) Transformed Expression (14)

Note that N is represented by the following Expression (15).

[Math. 14]

N=N_{Ack}+N_{Nack} Expression (15)

With this, the base station apparatus 200 can perform setting of the MCS in which a second correction value θ is considered. As illustrated in FIG. 7, it is possible to efficiently perform correction of a deviation from a control target caused by a factor in which time change by an individual difference between apparatuses is small.

### Other Embodiments

The individual methods may be combined and used.

In addition, different base station apparatuses 200 may be used according to, e.g., an environment in which the wireless communication system 10 is installed. Further, as the base station apparatus 200, by reference to results of use of the individual methods, an optimum base station apparatus or a base station apparatus having an excellent result may be adopted.

The disclosure can determine the MCS correspondingly to the wireless environment change in the short time period.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A base station apparatus comprising:
a controller which determines a value of a modulation and channel coding scheme to be applied at a transmission timing of a data packet required to have the decoding error probability below a target error rate; and
a transmitter which transmits data to a terminal apparatus, wherein
the controller acquires a distribution of variations between first communication quality used when the value of the modulation and channel coding scheme is determined and second communication quality at a time of data transmission and determines a correction value of the first communication quality according to the distribution of the variations and the target error rate, and
the transmitter transmits the data by using the modulation and channel coding scheme which is determined by communication quality corrected with the correction value.

2. The base station apparatus according to claim 1, wherein
the controller determines the correction value according to a value of a quantile value of the distribution of the variations at the target error rate.

3. The base station apparatus according to claim 1, wherein
the distribution of the variations includes a conditional distribution by the value of the modulation and channel coding scheme, and
the correction value is determined by using the conditional distribution corresponding to the value of the modulation and channel coding scheme before application of the correction value.

4. The base station apparatus according to claim 1, wherein
the controller acquires a distribution of communication quality, calculates a lower limit value of the communication quality from the distribution, calculates an MCS lower limit value of the modulation and channel coding scheme corresponding to the lower limit value, and performs control such that the modulation and channel coding scheme to which the correction value is applied does not become less than the MCS lower limit value.

5. The base station apparatus according to claim 1, wherein
the controller adds a second correction amount determined by using presence/absence information of an error after data re-transmission to the correction value.

6. A communication control method in a base station apparatus which transmits data to a terminal apparatus, the communication control method comprising:
determining a value of a modulation and channel coding scheme to be applied at a transmission timing of a data packet required to have the decoding error probability not more than a target error rate; and
transmitting the data to the terminal apparatus, wherein
the determining includes a process of acquiring a distribution of a variations between first communication quality used when the value of the modulation and channel coding scheme is determined and second communication quality at a time of data transmission and a process of determining a correction value of the first communication quality according to the distribution of the variations and the target error rate, and
the transmitting includes a process of transmitting the data by using the modulation and channel coding scheme which is determined by communication quality corrected with the correction value.

7. A wireless communication system comprising:
a terminal apparatus; and
a base station apparatus, wherein
the base station apparatus includes:
a controller which determines a value of a modulation and channel coding scheme to be applied at a transmission timing of a data packet required to have the decoding error probability not more than a target error rate; and
a transmitter which transmits data to the terminal apparatus,
the controller acquires a distribution of variations between first communication quality used when the value of the modulation and channel coding scheme is determined and second communication quality at a time of data transmission and determines a correction value of the first communication quality according to the distribution of the difference amount and the target error rate,
the transmitter transmits the data by using the modulation and channel coding scheme which is determined by communication quality corrected with the correction value, and
the terminal apparatus includes:
a terminal transmitter which transmits the first communication quality to the base station apparatus; and
a terminal receiver which receives the data transmitted by the base station apparatus.
